(19) United States
(12) Patent Application Publication
(10) Pub. No.: US 2018/0061626 A1
(43) Pub. Date: Mar. 1, 2018

(54) HIGH-INTENSITY DISCHARGE LAMP

(71) Applicant: KONINKLIJKE PHILIPS N.V., Eindhoven (NL)

(72) Inventor: Klaus Schoeller, Aachen (DE)

(21) Appl. No.: 15/556,584

(22) PCT Filed: Mar. 11, 2016
(86) PCT No.: PCT/EP2016/055260

§ 371 Date: Sep. 7, 2017

(30) Foreign Application Priority Data
Mar. 20, 2015 (EP) 15159982.6

(51) Int. Cl. H01J 61/073; H01J 61/30

(52) U.S. Cl. CPC H01J 61/0732; F21S 48/1186; H01J 61/302; H01J 61/0735

(57) ABSTRACT

The present invention relates to a high-intensity discharge lamp (1) comprising a discharge vessel (2) enclosing a filling in a discharge chamber (3), and a pair of electrode rods (4, 5) being formed of a material which is free of thorium and protruding from opposite sides into the discharge chamber (3). The diameter ED of the electrode rods (4, 5) in the discharge chamber (3) N satisfies the formula (I), wherein W represents the value of the nominal lamp power in mW and Ed represents the value of the distance of the electrode rods (4, 5) in the discharge chamber (3) in mm, and wherein the nominal lamp power W is between 20 W and 50 W. With the above formula, high-intensity discharge lamps can be easily designed with different nominal powers and/or 10 electrode distances without time consuming experiments in order to achieve an optimum performance.

$$ED \geq {ED}_{0} = \sqrt{π W / [ 1 + \frac{Ed - 3}{3 Ed} ]} μm - 10 μm , \qquad ( I )$$

### FIELD OF THE INVENTION

The present invention relates to a high-intensity discharge (HID) lamp comprising a discharge vessel enclosing a filling in a discharge chamber, and a pair of electrode rods being formed of a material which is free of thorium and protruding from opposite sides into the discharge chamber. Such HID lamps may be used for example in automotive applications, in particular in headlamps.

### BACKGROUND OF THE INVENTION

High-intensity discharge lamps should have a long lifetime and a high light output that is maintained over the lifetime of the lamp. The lamp performance is influenced for example by the size and distance of the electrodes and by the composition of the filling, which typically comprises an inert gas and a salt fill, usually introduced in the form of pellets which vaporize during operation. The salt fill can comprise a number of metal halides chosen according to their specific properties, in particular for their contribution to the color point of the lamp.

Based on the different multifunctional requirements, in particular in case of automotive lamps, it is very difficult, enormous extensive and also expensive to optimize a HID lamp or to design a new lamp with altered specifications of lamp power and/or electrode distance. The electrode diameter is a critical dimension of a HID lamp. If the electrode diameter is too large, several disadvantages may result, for example a difficult pinch process, zero hour defects or commutation problems. If the electrode diameter is too low, the lifetime of the lamp may fall short due to strong electrode burn-back and electromagnetic interference (EMI) may occur which—in particular in automotive applications—may have a negative impact on the electronic system in the surrounding e.g. in a car.

EP 2 725 604 A1 describes a metal halide lamp comprising a discharge vessel enclosing a filling in a discharge chamber, and a pair of electrode rods protruding from opposite sides into the discharge chamber. The filling includes a metal halide and a rare gas. Neither the electrodes nor the discharge chamber contain any thorium, which is typically used as an emitter material to lower the work function of the electrode. In order to avoid flickering of the lamp and deformation of the electrodes, the startup power W_{L} is dimensioned according to a rule which includes the electrode diameter D. The startup power value W_{L} is obtained by adding up the electric power supplied to the lamp during a period after the startup of the lamp. The startup power is selected to satisfy 4300≦W_{L}/D≦7400 for lamps having a nominal power P between 20 W and 30 W. This rule is mainly intended to avoid overheating and/or deformation of the electrodes during start up due to the lack of an emitter in the electrodes or in the discharge chamber. The document only deals with problems at the startup phase of the lamp but not with the characteristics of the stable lighting period.

### SUMMARY OF THE INVENTION

It is an object of the present invention to provide a high-intensity discharge lamp, in particular for automotive applications, which provides a high-intensity light output over a reasonably long lifetime and allows a redesign for other nominal lamp powers and/or other electrode distances in a simple time saving manner.

The object is achieved with the high-intensity discharge lamp according to claim 1. Advantageous embodiments of this discharge lamp are subject matter of the dependent claims or are described in the subsequent portions of the description.

The proposed HID lamp, which is preferably free of mercury, comprises a discharge vessel enclosing a filling in a discharge chamber, and a pair of electrode rods protruding from opposite sides into the discharge chamber. The diameter ED of the thorium-free electrode rods in the discharge chamber satisfies the following formula:

$$ED \geq {ED}_{0} = \sqrt{\frac{π W}{[ 1 + \frac{Ed - 3}{3 Ed} ]}} μm - 10 μm ,$$

In this equation, W represents the value of the nominal lamp power in mW and Ed represents the value of the distance of the electrode rods in the discharge chamber in mm. The electrode rods may have any appropriate cross section which is preferably circular but may also have other shapes. In case of a non-circular cross section the diameter refers to the maximum extension of the electrode rod in the plane perpendicular to the longitudinal axis of the electrode rod. The accuracy of manufacturing the electrode rods in praxis of about ±10 μm is already included in the above formula.

Since the electrode diameter is very important for the light output, lifetime, maintenance, commutation etc. of a HID lamp and in particular for the EMI behavior of automotive lamps, an optimization of a HID lamp always focuses on the diameter of the electrodes. Until now for new or improved lamps having a different nominal lamp power and/or electrode distance than an existing lamp, the best electrode diameter had to be developed with individual experiments and their analysis including the lifetime, which is very time consuming, e.g. about eight months for one experiment with lifetime test in the automotive sector. The inventor surprisingly found that with the above formula, a minimal electrode diameter can be found for nominal lamp powers between 20 W and 50 W and for a large range of electrode distances, which fulfills all important general criteria of HID lamps including the EMI behavior. Since the minimal electrode diameter according to this formula is dependent on the electrode distance and the nominal lamp power, a change of one or both of these parameters does not require an extensive and expensive new development, the optimal electrode diameter can rather be calculated in short time. Until now no reasonable correlation between the nominal lamp power and the electrode distance to the electrode diameter was known.

In the proposed HID lamp, the electrode rods are formed of a material which is free of thorium. Emitters like thorium are often used in the electrodes of HID lamps in order to lower the work function of the electrode and thus enable cathode electron emission at lower electrode temperatures. This avoids extreme heating of the electrodes during run-up of the lamp. To this end the bulk electrode material is often doped with thorium oxide (ThO₂). The oxygen contained in the thorium oxide however has also disadvantages on the chemistry in the lamp, leading ultimately to a drop in light output over the lifetime of the lamp. The electrode rods of the proposed high-intensity discharge lamp are thus formed of a material which is free of thorium. In a preferred embodiment the electrode rods are formed of a material which is free of any emitter or at least free of lanthanum or yttrium. This means that the electrode is manufactured without including any thorium oxide or other emitters like e.g. lanthanum or yttrium. Preferably the electrode rods are primarily made of tungsten.

In order to lower the work function of the electrodes, the proposed high-intensity discharge lamp preferably comprises an emitter, in particular thorium, a thorium composition or a thorium compound, in the filling. The filling typically includes a halide composition, typically in the form of a salt, which evaporates when the discharge chamber is heated during operation of the lamp. In the present embodiment, this filling includes the corresponding emitter. Preferably the filling includes a salt of halides including at least 8% ThI₄, preferably 10% ThI₄. This ratio of a thorium compound advantageously lowers the work function of the electrode rods and thus further improves the light output and enlarges the lifetime of the lamp. The filling may for example include a mixture of NaI/ScI_{3/}ThI₄. The composition of the filling is appropriately adjusted to control variations in lumen output, position of the color point relative to the black body line etc. The filling may additionally include for example a halide composition comprising ZnI₂ and/or InI in order to further influence the color point of the lamp. Also other compounds may be included. It is obvious for the skilled person, that any reference to a metal halide by the chemical formula, for example ThI₄ for thorium iodide, does not preclude the use of another metal salt of that metal and halogen. For example, in the high-intensity discharge lamp according to the invention, the thorium halide could also be any of thorium bromide, thorium chloride or thorium fluoride.

The electrodes of a high-intensity discharge lamp protrude into opposite ends of the discharge chamber. Because of the distorting refractive properties of the material of the discharge vessel, typically quartz glass, the actual distance of the electrodes can not be optically determined from outside, and is usually carried out using, for example, an X-ray technique. For this reason, the electrode separation is sometimes expressed as an optical separation. In the present patent application, the electrode distance means the real electrode distance and not the optical distance. The maintenance of a stable arc depends to a large extend on the geometry of the electrodes, in particular their diameter, since the thickness of the electrodes governs the electrode temperature that is reached during operation. This in turn determines the commutation behavior and the burn-back of the electrodes according to the ballast parameters. An electrode can be realized as a simple rod shape of uniform diameter from tip to pinch or can also be realized with a different diameter inside the discharge chamber compared to the part of the electrode within the pinch. The above formula of the present invention relates to the (constant) diameter ED of the electrode rods inside the discharge chamber. Since too large electrode diameters are not favorable, the diameter ED of the electrode rods of the proposed HID lamp are preferably selected to be in the range between ED₀ and ED₀+60 μm, more preferably between ED₀ and ED₀+40 μm. Very good results are achieved with distances of the electrode rods which are between 2.0 and 4.0 mm.

The proposed high-intensity discharge lamp may be advantageously used in automotive applications, in particular in place of prior art D1 to D9 head lamps of S and R type.

### BRIEF DESCRIPTION OF THE DRAWING

The proposed high-intensity discharge lamp is described in the following by way of examples in connection with the accompanying figure.

FIG. 1 shows a cross section of a HID lamp according to an embodiment of the invention.

### DESCRIPTION OF EMBODIMENTS

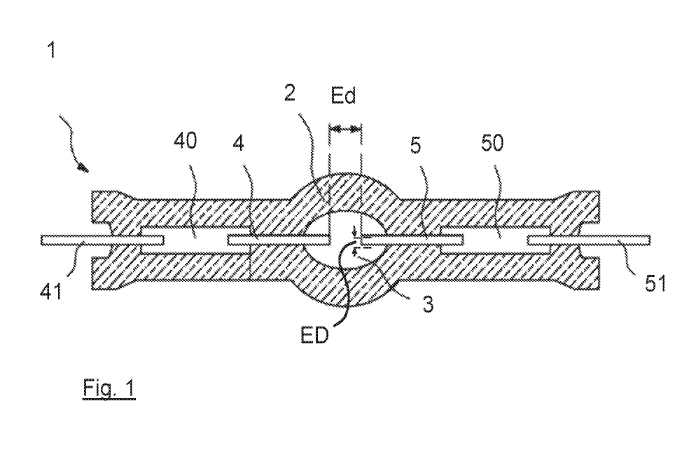

FIG. 1 shows a cross section of a mercury-free quartz glass HID lamp 1 according to an embodiment of the present invention. The lamp 1 comprises a quartz glass discharge vessel 2 enclosing a discharge chamber 3 containing a fill gas. The inner diameter of the discharge chamber 3 shown in this example can be between 2.0 mm and 2.8 mm, and the outer diameter can be between 5.3 mm and 6.3 mm. This results in a capacity of the discharge chamber 3 between 15 μl and 30 μl. Two electrode rods 4, 5 protrude into the discharge chamber 3 from opposite ends of the lamp 1. During manufacturing, the quartz glass of the discharge vessel 2 is pinched on both sides around the shafts of the electrodes to seal the fill gas in the discharge chamber 3. An electrical connection between the electrode rods 4, 5 and conductive leads 41, 51 to the outside is made by a molybdenum foil 40, 50 enclosed in the pinch or seal area. The electrode rods 4, 5 therefore extend a certain distance into the pinch.

The electrodes rods 4, 5 are made from tungsten and manufactured to be essentially free of thorium and protrude into the discharge chamber 3. The tips of the electrode rods 4, 5 are separated from each other by a certain distance. This electrode distance may be in the range of between 2.0 and 4.0 mm dependent on the type of the lamp, e.g. satisfying D3 or D4 specifications. In the present example, the electrode rods 4, 5 of the lamp 1 are realized in form of simple rods of uniform thickness from base to tip. The thickness or diameter ED of these electrode rods 4, 5 is selected to be ≧ED₀ in accordance with the formula

$$ED \geq {ED}_{0} = \sqrt{π W / [ 1 + \frac{Ed - 3}{3 Ed} ]} μm - 10 μm ,$$

For sake of clarity, the figure shows only the parts that are pertinent to the invention. Not shown is the base and the ballast that is required for the lamp for control of the current or power of the lamp. Since these and other additional components will be known to a person skilled in the art, they will not be explained in any detail here. When the lamp is switched on, the ballast's igniter rapidly applies an ignition voltage at several thousand volts across the electrode rods 4, 5 to initiate a discharge arc. The temperature in the discharge chamber increases rapidly, and the metal salts evaporate. While the arc of high luminous intensity is gradually established, the ballast regulates the power down to the operational level (nominal power), for example 35 W for a D4 lamp.

In a first example, the proposed high-intensity discharge lamp is designed for a nominal power of 35 W and has a volume of the discharge chamber of 27 μl and a electrode distance of 3.7 mm (optical separation: 4.2 mm). The diameter of the electrode rods is 320 μm which satisfies the above formula. The rate of the total salt fill in the filling of the lamp in this example is 300 μg. The filling is a composition of NaI/ScI₃/ThI₄ with or without InI or ZnI₂. The filling may also contain other substances dependent on the desired effects.

In a second example a high-intensity discharge lamp with a nominal lamp power of 25 W is provided with a volume of the discharge chamber of 20 μl and an electrode distance of 3.5 mm. In this case the diameter of the electrode rods is chosen to be 290 μm which also satisfies the above formula. The total salt fill in this example is 200 μg. The filling is a composition of NaI/ScI₃/ThI₄ with or without InI or ZnI₂. The filling may also contain other substances dependent on the desired effects.

In a third example, the high-intensity discharge lamp has a nominal power of 27 W, a volume of the discharge chamber of 21 μl and an electrode distance of 2.6 mm. The diameter of the electrode rods is 300 μm which also satisfies the above formula. The total salt fill in this case is 250 μg. The filling is a composition of NaI/ScI₃/ThI₄ with or without InI or ZnI₂. The filling may also contain other substances dependent on the desired effects.

All of the above examples result in a high-intensity discharge lamp having a high-intensity output over a long life time of the lamp and at the same time low EMI and no commutation problems. The electrode diameter necessary for such a performance can be easily calculated with the above formula according the present invention, thereby avoiding any time consuming experiments and tests in order to find the electrode diameter for optimal performance.

While the invention has been illustrated and described in detail in the drawings and foregoing description, such illustration and description are to be considered illustrative or exemplary and not restrictive. The invention is not limited to the disclosed embodiments. Other variations to the disclosed embodiments can be understood and effected by those skilled in the art in practicing the claimed invention, from a study of the drawings, the disclosure and the appended claims. In the claims the word “comprising” does not exclude other elements or steps and the indefinite article “a” or “an” does not exclude a plurality. The mere fact that certain measures are recited in mutually different dependent claims does not indicate that a combination of these measures cannot be used to advantage. Any reference signs in the claims should not be construed as limiting the scope of the invention.

### LIST OF REFERENCE SIGNS

1 HID lamp

2 discharge vessel

3 discharge chamber

4 electrode rod

5 electrode rod

40 molybdenum foil

41 conductive lead

50 molybdenum foil

51 conductive lead

ED diameter of electrode rods

Ed distance of electrode rods in the discharge chamber

1. High-intensity discharge lamp comprising a quartz glass discharge vessel enclosing a filling in a discharge chamber, and a pair of electrode rods of simple rod shape being formed of a material which is free of thorium and protruding from opposite sides into the discharge chamber,
wherein the discharge chamber has an inner diameter between 2.0 mm and 2.8 mm and an outer diameter between 5.3 mm and 6.3 mm, and
wherein a diameter ED of said electrode rods in the discharge chamber satisfies the formula:
$$ED \geq {ED}_{0} = \sqrt{π W / [ 1 + \frac{Ed - 3}{3 Ed} ]} μm - 10 μm ,$$
W representing a value of the nominal lamp power in mW and Ed representing a value of a distance of the electrode rods in the discharge chamber in mm, and wherein the nominal lamp power W is between 20 W and 50 W.

2. The lamp according to claim 1, wherein the electrode rods are formed of a material which is free of any emitter.

3. The lamp according to claim 1, wherein the diameter ED of the electrode rods is between ED₀ and ED₀+40 μm.

4. The lamp according to claim 1, wherein the distance of the electrode rods in the discharge chamber is between 2.0 and 4.0 mm.

5. The lamp according to claim 1, wherein the filling includes an emitter.

6. The lamp according to claim 5, wherein the filling includes thorium or a thorium composition or compound as the emitter.

7. The lamp according to claim 6, wherein the filling includes a salt of halides including at least 8% ThI₄, preferably 10% ThI₄.

8. The lamp according to claim 6, wherein the filling includes a composition of NaI/ScI₃/ThI₄.
